(19) United States
(12) Patent Application Publication
(10) Pub. No.: US 2013/0246681 A1
(43) Pub. Date: Sep. 19, 2013

(54) POWER GATING FOR HIGH SPEED XBAR ARCHITECTURE

(71) Applicants: Hari M. Rao, San Diego, CA (US); Esin Terzioglu, San Diego, CA (US); Venugopal Boynapalli, San Diego, CA (US)

(72) Inventors: Hari M. Rao, San Diego, CA (US); Esin Terzioglu, San Diego, CA (US); Venugopal Boynapalli, San Diego, CA (US)

(73) Assignee: QUALCOMM Incorporated, San Diego, CA (US)

(21) Appl. No.: 13/419,960

(22) Filed: Mar. 14, 2012

(51) Int. Cl. G06F 13/36

(52) U.S. Cl. 710/306

(57) ABSTRACT

A low power interconnect allows client to client communication using an XBAR architecture. An XBAR compiler generates chip designs with XBAR data paths structured to reduce energy consumption and delay. Repeaters inserted into XBAR data paths reduce resistance capacitance (RC) delays so that a design can support desired frequency specifications along a path. Dynamic power consumption is reduced by inserting latch repeaters in the XBAR track. The latch repeaters each include a transmission gate and a latch. Select circuitry couples selected clients to a path. Enable circuitry opens the transmission gates located on the path between the selected clients. Latch repeaters that are not enabled on a given communication cycle gate off the unused portions of the path and maintain the data that was latched on a previous cycle.

### TECHNICAL FIELD

The present disclosure relates generally to integrated circuit (IC) bus architecture. More specifically, the present disclosure relates to a low power on-chip bus architecture for interconnecting selectable client circuitry with selected path segments.

### BACKGROUND

Integrated circuit bus architectures interconnect multiple client subsystems in an N-way configuration in which each client may be connected to each of the other clients on a bus. A crossbar network topology switch interconnects selected clients. The crossbar topology includes non-blocking switches, which are configured to concurrently switch connections between different combinations of clients on a bus. Multiplexing circuitry can provide direct connection between selected clients and allows traffic to be forwarded from one client to a number of other clients simultaneously. Complex bus arbitration algorithms allow any client to write to the bus and any client to read from the bus.

A particular crossbar switching configuration, referred to as XBAR, is becoming increasingly important to implement client to client connectivity in high speed circuitry such as modern and graphics processing circuitry. The operation of XBAR at high frequencies generally involves the use of repeaters and latch repeaters that increase dynamic power consumption.

Typical XBAR configurations are implemented without channels using standard place and route (P&R) flow techniques. Such configurations consume a large amount of dynamic power, increase congestion and operate at relatively low speeds. Such configurations also consume a large area on a chip and present timing closure problems.

XBAR architectures allow multiple clients to simultaneously access another particular client or subsystem. Each client may write to and read from the XBAR in an N-way communication scheme. N-way multiplexing is used to sample specific clients on a cycle by cycle basis. Multiplexer select circuitry determines which clients can write to the XBAR system and which clients can listen to the XBAR system. The N-way multiplexer circuitry adds diffusion capacitance that is linear with N in typical implementations. The large amount of diffusion capacitance associated with the N-way multiplexor circuitry increases dynamic power consumption and delay throughout the XBAR.

### SUMMARY

An on-chip interconnect architecture such as an XBAR architecture includes multiple paths and repeater circuitry to allow any of a number of selected clients to communicate with any of the other interconnected clients. The present disclosure saves dynamic power by selectively gating off portions of the paths not used during a communication cycle between selected clients.

One aspect of the present disclosure includes a method of reducing dynamic power in an XBAR architecture by gating latch repeaters based on cycle by cycle traffic. Particular latch repeaters are enabled based on downstream traffic and based on the particular clients that are selected to communicate with each other, This allows unused sections of the XBAR architecture to be gated off. Very high speed client to client communication is thereby provided while dynamic power is conserved.

According to aspects of the present disclosure, repeater circuitry, such as latch repeater circuitry, is included on the data path between clients. The latch repeaters each include a transmission gate and a latch. Select circuitry couples selected clients to a path. Enable circuitry opens the transmission gates located on the path between the selected clients. The latch repeaters that are not enabled on a given communication cycle gate off the unused portions of the path and maintain the data that was latched on a previous cycle.

A design for test (DFT) implementation includes a global DFT signal and a latch enable DFT Signal that define functional modes and DFT modes of the latch repeater circuitry.

According to one aspect of the disclosure, a tow power interconnect includes a path coupled between a number of selectable clients. Repeaters are configured in the path between the selectable clients. The repeaters are configured to couple selected portions of the path between selected clients in response to a select signal from select circuitry, which is coupled to the repeaters. The repeaters are further configured to gate off non-selected portions of the path.

Another aspect of the disclosure includes a method for reducing power on an XBAR system. The method includes receiving a first client select signal identifying a first client and coupling the first client to an XBAR path in response to the first client select signal. The method also includes propagating the first client select signal to a first set of repeaters between the first client and a second client on the XBAR path and turning on a first set of repeaters between the first client and the second client in response to the first client select signal. The first set of repeaters couple the first client and the second client, The method also includes turning off a second set of repeaters on the XBAR path in response to the first client select signal. The second set of repeaters decouples segments of the XBAR path that are not between the first client and the second client.

Another aspect of the disclosure includes an apparatus for reducing power on an XBAR system. The apparatus includes means for receiving a first client select signal identifying a first client and means for coupling the first client to an XBAR path in response to the first client select signal. The apparatus further includes means for propagating the first client select signal to a first set of repeaters between the first client and a second client on the XBAR path and means for turning on a first set of repeaters between the first client and the second client in response to the first client select signal. The first set of repeaters couples the first client and the second client. The apparatus also includes means for turning off a second set of repeaters on the XBAR path in response to the first client select signal. The second set of repeaters decouples segments of the XBAR path that are not between the first client and the second client.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a schematic diagram conceptually illustrating a general example of interconnect circuitry according to aspects of the present disclosure.

FIG. 2 is a schematic diagram conceptually illustrating a general example of an XBAR track according to aspects of the present disclosure.

FIG. 3 is a schematic diagram conceptually illustrating a general example of XBAR circuitry according to aspects of the present disclosure.

FIG. 4 is a schematic diagram conceptually illustrating a general example of XBAR design for test (DFT) circuitry according to aspects of the present disclosure.

FIG. 5 is a process flow diagram illustrating a method for reducing power on an XBAR according to an aspect of the present disclosure.

FIG. 6 shows an exemplary wireless communication system in which an XBAR circuitry configuration may be advantageously employed according to the present disclosure.

FIG. 7 is a block diagram illustrating a design workstation for circuit, layout, and logic design of XBAR circuitry according to one aspect of the present disclosure.

### DETAILED DESCRIPTION

An interconnect that allows client to client communication using an XBAR.

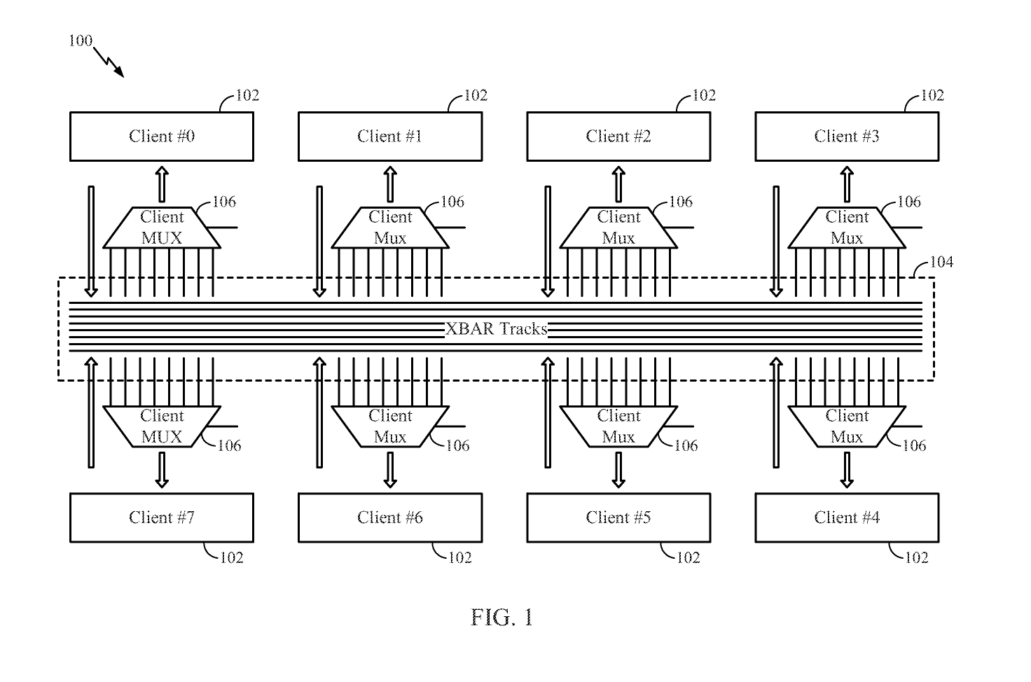

architecture is described with reference to FIG. 1. The interconnect 100 includes a number (N) of clients 102 coupled to XBAR tracks 104. The clients 102 may be various subsystems and modules such as separate processors and memories, for example.

According to aspects of the present disclosure, an XBAR compiler generates XBAR designs. XBAR compilers allow for rapid product development over a wide range of XBAR topologies. A user of the XBAR compiler may input design specifications, such as electrical specifications, frequency, orientation, layers, client information, and bus width, for example. An XBAR compiler can then generate a design including design views, such as verified electrical models for physical design integration, electrical models for top level integration, and place and route (P&R) flow for a chip, for example. According to an aspect of the disclosure, the views generated by the XBAR compiler are compatible with existing application specific integrated circuit (ASIC) P&R flows.

The XBAR compiler can generate chip designs with data paths structured to reduce energy consumption and delay. Repeaters are inserted into XBAR data paths to reduce resistance capacitance (RC) delays so that a design can support desired frequency specifications along a path. According to aspects of the present disclosure, the XBAR compiler may generate designs that are operable at very high frequencies in the range of 1 GHz, over a path of up to two millimeters, for example.

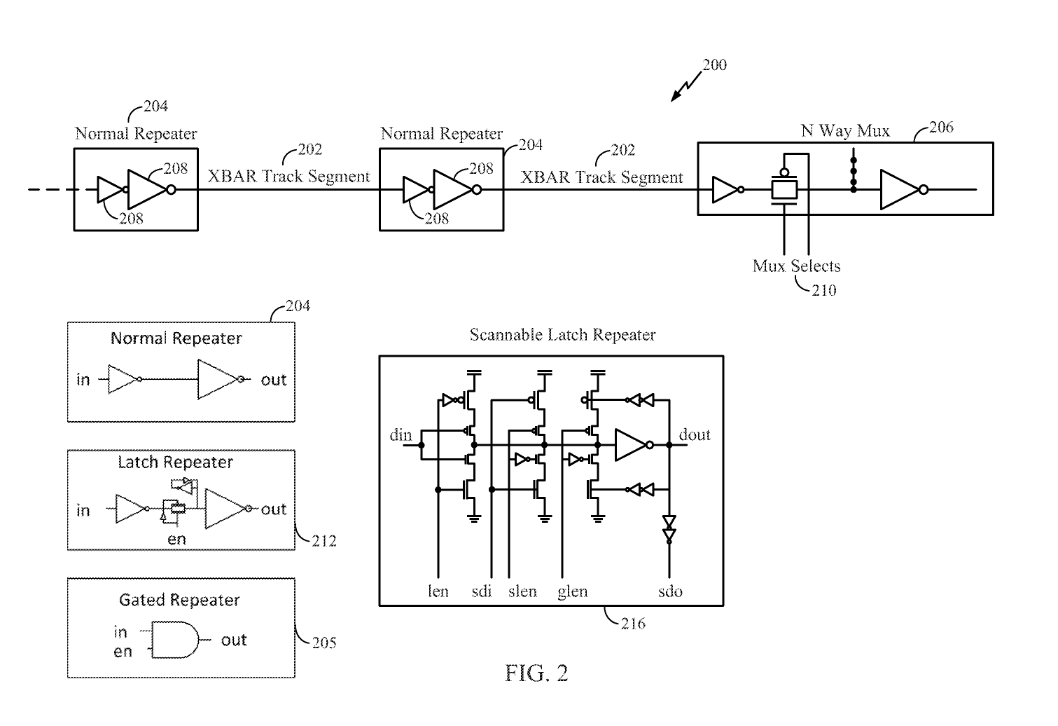

According to aspects of the present disclosure, the repeaters inserted into the XBAR data paths can be normal repeaters or latch repeaters, for example. Referring to FIG. 2, an XBAR track 200 includes XBAR track segments 202 coupled to normal repeaters 204 and an N-way multiplexer 206. The normal repeaters 204 each include a pair of inverters 208 coupled together in series. Multiplexer select circuitry 210 controls the N-way multiplexer 206 to enable data traffic on the XBAR track segments 202.

In one implementation where normal repeaters 204 are used on an XBAR. track 200 that connects a number of clients 102 as shown in FIG. 1, for example, data flows to all of the clients 102 on the XBAR track 200. Because data is allowed to flow to clients that are not intended recipients, data flows on certain XBAR track segments 202 unnecessarily. This wastes dynamic power by switching interconnects and using buffers located outside of a direct path between the clients 102 involved in data communication, for example.

In certain implementation, RC losses are reduced and dynamic power is conserved by inserting gated repeaters 205 in the XBAR track 200 in place of normal repeaters 204. A gated repeater 205 includes a controllable transmission gate such as a NAND gate and an inverter. According to aspects of the present disclosure, the gated repeater 205 can gate the data traffic flow from input to output by controlling the transmission gate.

In certain implementations, dynamic power consumption is reduced by inserting latch repeaters 212 in the XBAR track 200 in place of the normal repeaters 204. A latch repeater 212 includes a controllable transmission gate and latching circuitry between two inverters. According to aspects of the present disclosure, the latch repeater 212 gates the data traffic flow from input to output by controlling the transmission gate between the inverters.

The latch repeater 212 includes a latch repeater enable input (en). When the latch repeater enable input is turned on (en is HIGH), data traffic can flow through the latch repeater 212 from left to right. When the latch repeater enable input is turned off (en is LOW), data flow is automatically cut off from the rest of the XBAR track 200 at the latch repeater 212. Latch repeaters that are turned off maintain the previously latched value.

In certain implementations, when latch repeaters are included in the XBAR path 200, additional circuitry is added to provide for testing the XBAR path 200 in different possible states of the latch repeaters. According to one aspect of the disclosure, scannable latch repeaters 216 are included in the XBAR path 200 in place of a normal repeater 204 or a regular latch repeater 212. The scannable latch repeaters 212 include additional circuitry that allows the insertion of a test data flow to override normal data flow for testing the XBAR path 200.

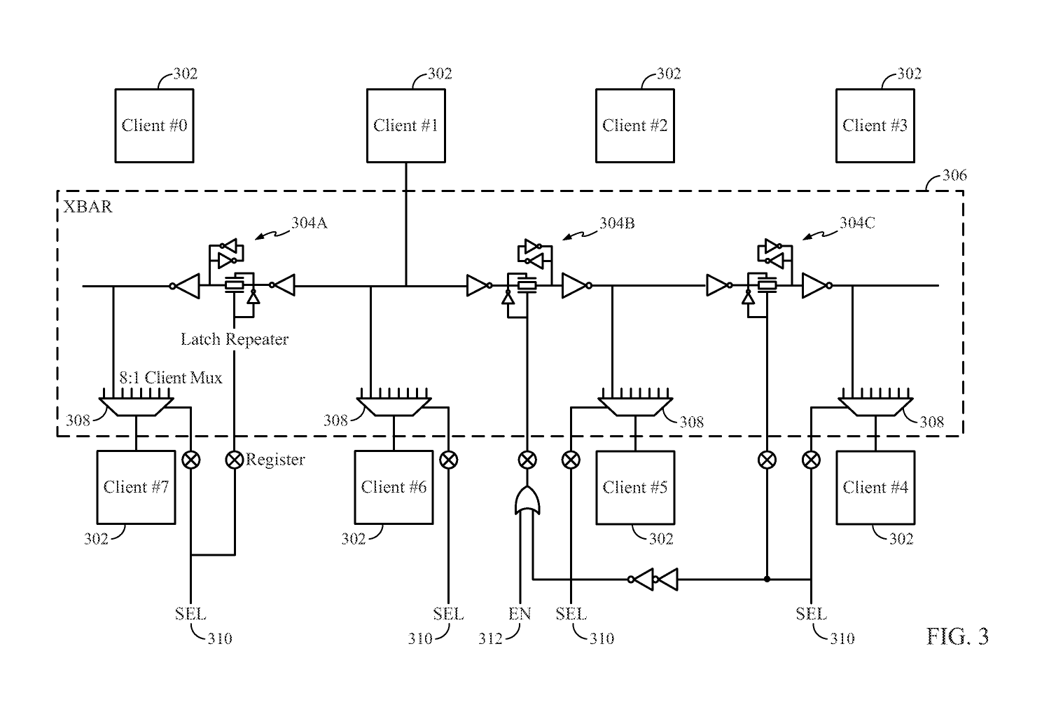

FIG. 3 shows an XBAR path 306 coupled to clients 302 though multiplexer circuitry 308 according to an implementation of the present disclosure. Latch repeaters 304A, 304B and 304C are included in the XBAR path 306. The multiplexer circuitry 308 enables a path between a first client, shown as client 1, and selected clients that are identified by a signal on client select circuitry 310. The latch repeaters 304A, 304B and 304C are configured to save dynamic power by gating off and latching inactive sections of the XBAR path 306. In addition to controlling the multiplexer circuitry 308, the client select circuitry 310 is configured to enable only the appropriate latch repeaters 304A, 304B and/or 304C between the first client and the selected clients. The latch repeaters 304A, 304B and 304C between the first client and selected clients are enabled by generating latch repeater enable signals based on a logical “OR” combination of multiplexer select signals between the first client and the selected clients. Enable circuitry 312 may also be included to directly enable particular latch repeaters 304A, 304B and 304C.

According to aspects of the present disclosure, the multiplexer select signals can be generated ahead of time or they can be generated within a data communication cycle. The manner of generating the multiplexer select signal may be chosen based on architecture constraints, such as time available for propagating a signal through the XBAR system, for example.

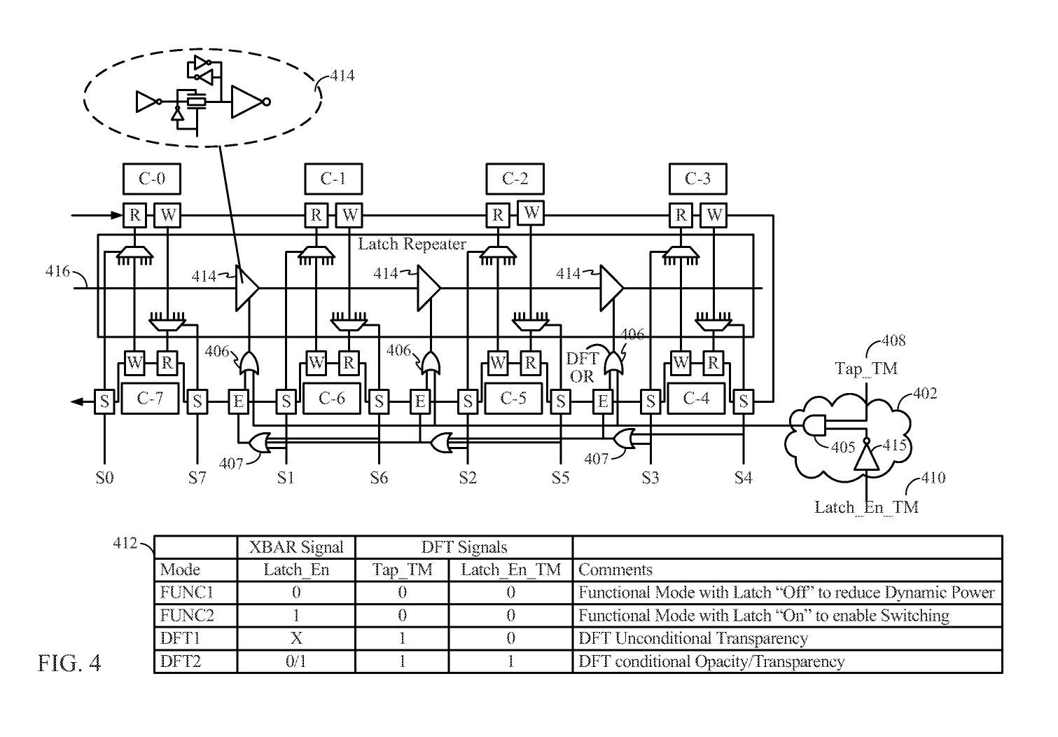

Because the latch repeaters include more than one available state, the inclusion of latch repeaters in an XBAR path according to the present disclosure calls for additional circuitry to enable testability of the available states. FIG. 4 shows an aspect of the disclosure including design for test (DFT) circuitry. The DFT circuitry includes XBAR DFT control input logic 402 coupled to DFT OR gates 406 for controlling the latch repeaters 414 on an XBAR path 416. The DFT control input logic 402 includes an AND gate 405 coupled to a global DFT signal input 408 and a conditional DFT input 410. The conditional input 410 is coupled to the AND gate 405 via an inverter 415. An output from the AND gate 405 is coupled to a first input of DFT OR gates 406. A second input to each of the DFT OR gates 406 is coupled to latch repeater enable circuitry. The latch repeater enable circuitry includes latch repeater enable OR gates 407 coupled to multiplexer select circuitry and is configured to propagate a latch enable signal to the latch repeaters 414 when the multiplexer select signal indicates that a client downstream of the latch repeater 414 is selected.

Referring to the table 412, a latch repeater 414 on an XBAR path 416 may be in a first functional mode (FUNC1) or a second functional mode (FUNC2) when a global DFT signal (Tap_TM) is not asserted (value ‘0’) on the global DFT control input 408. In the first functional mode of a latch repeater 414, its enable signal is not asserted (value ‘0’) so the latch repeater 414 is turned off to reduce dynamic power on the XBAR, in the second functional mode of the latch repeater 414, its enable signal is asserted (value ‘1’) so the latch repeater is turned on to enable switching.

When the global DFT signal (Tap_TM ) is asserted (value ‘1’) on the global DFT control input 408, a latch repeater 414 on the XBAR path 416 may be in a first DFT mode (DFT1) or a second DFT mode (DFT). In the first DFT mode, a latch enable test mode signal (Latch_En_TM) is not asserted (value ‘0’). An inverter 415 in the DFT control input logic 402 inverts the latch enable test mode signal (Latch_En_TM) so that the AND gate 405 outputs a logical ‘1’, which is propagated as global latch repeater enable signal to each of the latch repeaters 414. As a result, each of the latch repeaters is turned on in the first DFT mode, without regard to the logic level of their respective latch repeater enable signal, (Latch_En).

In the second DFT mode, the Latch_En_TM is asserted (value ‘2’) so that the AND gate 405 outputs a logical ‘0’. As a result, each of the latch repeaters 414 is responsive to their respective latch enable signal in the second DFT test mode.

Although specific circuitry has been set forth, it will be appreciated by those skilled in the art that not all of the disclosed circuitry is required to practice the disclosed configurations. Moreover, certain well known circuits have not been described, to maintain focus on the disclosure.

In one configuration, an apparatus for reducing power on an XBAR includes means for receiving a first client select signal identifying a first client, means for coupling the first client to an XBAR path in response to the first client select signal, and means for propagating the first client select signal to a first set of repeaters between the first client and a second client on the XBAR path. The apparatus also include means for turning on a first set of repeaters between the first client and the second client in response to the first client select signal and means for turning off a second set of repeaters on the XBAR path in response to the first select signal. The second set of repeaters decouples segments of the XBAR path that are not between the first client and the second client. The means for receiving the first client signal and means for coupling the first client to the XBAR path may be client select circuitry 310 and multiplexer circuitry 308 for example. The means for propagating the first client select signal, means for turning on a first set of repeaters between the first client and the second client and means for turning off a second set of repeaters on the XBAR path may be combinations of latch repeater enable circuitry 312 and client select circuitry 310, for example. Although specific means have been set forth, it will be appreciated by those skilled in the art that not all of the disclosed means are required to practice the disclosed configurations. Moreover, certain well known means have not been described, to maintain focus on the disclosure.

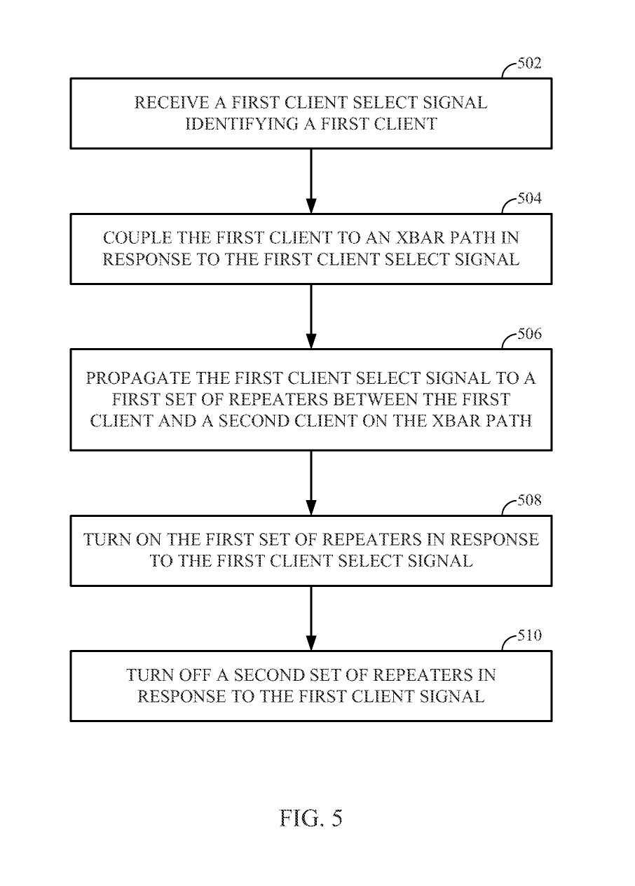

A method for reducing power on an XBAR system according to aspects of the present disclosure is described with reference to FIG. 5. In block 502, the method includes receiving a first client select signal identifying a first client. In block 504, the method includes coupling the first client to an XBAR path in response to the first client select signal. In block 506, the method includes propagating the first client select signal to a first set of repeaters between the first client and a second client on the XBAR path. In block 508, the method includes turning on the first set of repeaters in response to the first client select signal. The first set of repeaters couple the first client and the second client. In block 510, the method includes turning off a second set of repeaters on the XBAR path in response to the first select signal, the second set of repeaters decoupling segments of the XBAR path that are not between the first client and the second client.

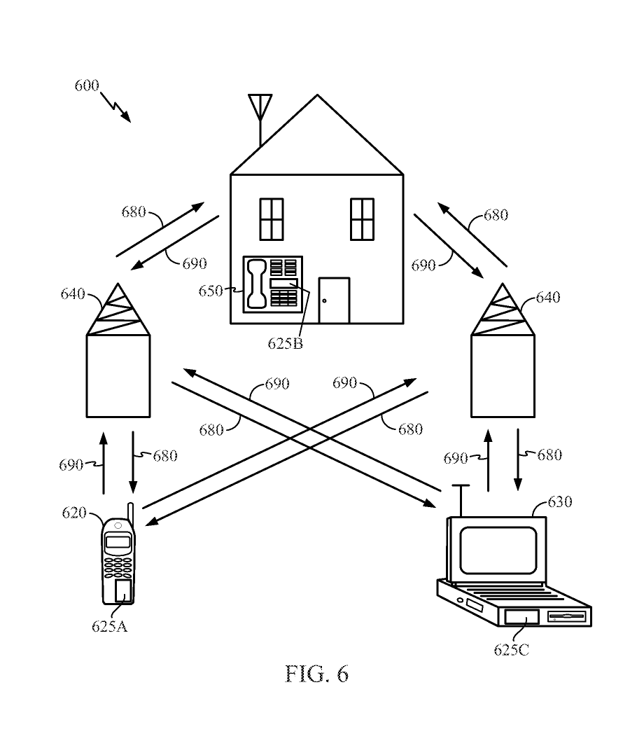

FIG. 6 shows an exemplary wireless communication system 600 in which a configuration of the disclosed XBAR circuitry may be advantageously employed. For purposes of illustration, FIG. 6 shows three remote units 620, 630, and 650 and two base stations 640. It will be recognized that wireless communication systems may have many more remote units and base stations. Remote units 620, 630, and 650 include the XBAR circuitry 625A, 625B, and 625C, respectively. FIG. 6 shows forward link signals 680 from the base stations 640 and the remote units 620, 630, and 650 and reverse link signals 690 from the remote units 620, 630, and 650 to base stations 640.

In FIG. 6, the remote unit 620 is shown as a mobile telephone, remote unit 630 is shown as a portable computer, and remote unit 650 is shown as a fixed location remote unit in a wireless local loop system. For example, the remote units may be cell phones, hand-held personal communication systems (PCS) units, portable data units such as personal data assistants, or fixed location data units such as meter reading equipment. Although FIG. 6 illustrates remote units, which may employ XBAR circuitry according to the teachings of the disclosure, the disclosure is not limited to these exemplary illustrated units. For instance, XBAR circuitry according to configurations of the present disclosure may be suitably employed in any device.

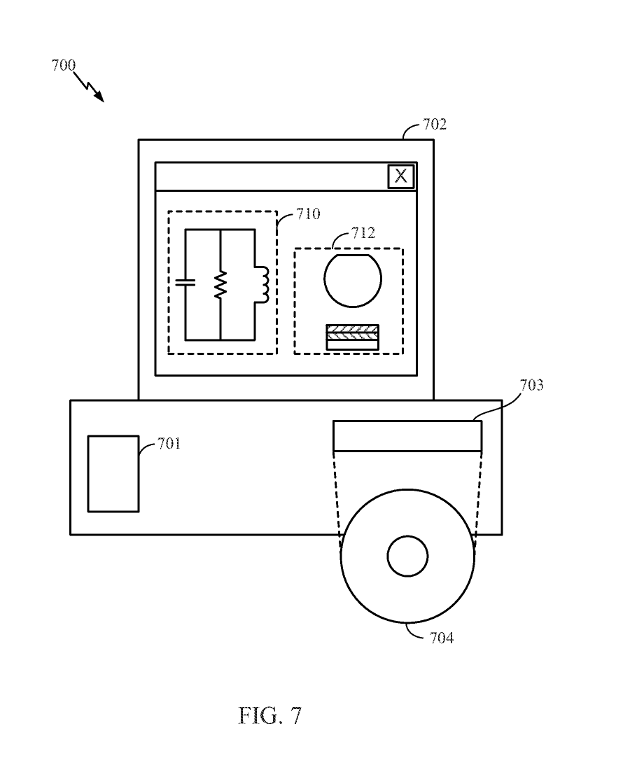

FIG. 7 is a block diagram illustrating a design workstation used for circuit, layout, and logic design of chip circuitry, such as the XBAR circuitry disclosed above. A design workstation 700 includes a hard disk 701 containing operating system software, support files, and design software such as Cadence or OrCAD. The design workstation 700 also includes a display 702 to facilitate design of a circuit 710 or a semiconductor component 712, such as the XBAR circuitry. A storage medium 704 is provided for tangibly storing the circuit design 710 or the semiconductor component design 712. The circuit design 710 or the semiconductor component design 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit design 710 or the semiconductor component design 712 by decreasing the number of processes for designing semiconductor wafers.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular configurations of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A low-power interconnect, comprising:
a first path coupled between a plurality of selectable clients;
a plurality of repeaters configured in the first path between the selectable clients; and
select circuitry coupled to the plurality of repeaters;
the repeaters configured to couple selected portions of the first path between selected clients of the plurality of selectable clients in response to a select signal from the select circuitry, the repeaters further configured to gate off non-selected portions of the first path.

2. The low-power interconnect of claim 1, further comprising:
multiplexor circuitry coupled in the first path between the plurality of selectable clients, the multiplexor circuitry further coupled to the select circuitry and configured to couple selected clients to the selected portions of the first path in response the select signal.

3. The low-power interconnect of claim 1, in which the first path comprises an XBAR architecture.

4. The low-power interconnect of claim 1, in which the repeaters comprise gated repeaters.

5. The low-power interconnect of claim 1, in which the repeaters comprise latch repeaters.

6. The low-power interconnect of claim 5, in which the latch repeaters include:
a first inverter;
a second inverter;
a transmission gate between the first inverter and the second inverter, the transmission gate configured to gate off portions of the first path; and
a latch between the first inverter and the second inverter, the latch configured to hold repeater configured to hold a previous state.

7. The low-power interconnect of claim 5, further comprising:
a global design for test (DFT) signal path coupled to the plurality of latch repeaters; and
a latch enable DFT signal path coupled to the plurality of latch repeaters;
the global DFT signal path and the latch enable DFT signal path configured to enable selection between a plurality of functional modes and a plurality of DPT modes of the plurality of latch repeaters.

8. The low-power interconnect of claim 1, integrated in at least one of a mobile phone, a set top box, a music player, a video player, an entertainment unit, a navigation device, a computer, a hand-held personal communication systems (PCS) unit, a portable data unit, and a fixed location data unit.

9. A method for reducing power on an XBAR system, comprising:
receiving a first client select signal identifying a first client;
coupling the first client to an XBAR path in response to the first client select signal;
propagating the first client select signal to a first set of repeaters between the first client and a second client on the XBAR path;
turning on the first set of repeaters in response to the first client select signal, the first set. of repeaters coupling the first client and the second client;
turning off a second set of repeaters on the XBAR path in response to the first client select signal, the second set of repeaters decoupling segments of the XBAR path that are not between the first client and the second client.

10. The method of claim 9, further comprising:
latching a previous state of the second set of repeaters.

11. The method of claim 9, further comprising integrating the XBAR system into at least one of a mobile phone, a set top box, a music player, a video player, an entertainment unit, a navigation device, a computer, a hand-held personal communication systems (PCS) unit, a portable data unit, and a fixed location data unit.

12. An apparatus for reducing power on an XBAR system comprising:
means for receiving a first client select signal identifying a first client;
means for coupling the first client to an XBAR path in response to the first client select signal;
means for propagating the first client select signal to a first set of repeaters between the first client and a second client on the XBAR path;
means for turning on the first set of repeaters in response to the first client select signal;
the first set of repeaters coupling the first client and the second client; and
means for turning off a second set of repeaters on the XBAR path in response to the first client select signal, the second set of repeaters decoupling segments of the XBAR path that are not between the first client and the second client.

13. The apparatus of claim 12, further comprising:
means for latching a previous state of the second set of repeaters.

14. The apparatus of claim 12, integrated in at least one of a mobile phone, a set top box, a music player, a video player, an entertainment unit, a navigation device, a computer, a hand-held personal communication systems (PCS) unit, a portable data unit, and a fixed location data unit.

15. A computer program product for designing an XBAR system, comprising:
a non-transitory computer-readable medium having program code recorded thereon, the program code comprising:
program code to generate a path between a plurality of selectable clients;
program code to generate a plurality of repeaters in the path between the selectable clients;
program code to generate select circuitry coupled to the plurality of repeaters; and
program code to configure the repeaters to couple selected portions of the path between selected clients of the plurality of selectable clients in response to a select signal from the select circuitry, the repeaters further configured to gate off non-selected portions of the path.

16. The computer program product of claim 15, in which the program code further comprises:
program code to configure the repeaters to latch a previous state when gating off the non-selected portions of the path.

17. The computer program product of claim 15, further comprising:
program code to integrate the XBAR system in at least one of a mobile phone, a set top box, a music player, a video player, an entertainment unit, a navigation device, a computer, a hand-held personal communication systems (PCS) unit, a portable data unit, and a fixed location data unit.

18. A method for reducing power on an XBAR comprising steps of:
receiving a first client select signal identifying a first client;
coupling the first to an XBAR path in response to the first client select signal;
propagating the first client select signal to a first set of repeaters between the first client and a second client on the XBAR path;
turning on the first set of repeaters in response to the first client select signal; the first set of repeaters coupling the first client and the second client; and
turning off a second set of repeaters on the XBAR path in response to the first client select signal, the second set of repeaters decoupling segments of the XBAR pa h that are not between the first client and the second client.

19. The method of claim 18, further comprising a step of:
latching a previous state of the second set of repeaters

20. The method of claim 18, further comprising a step of integrating the XBAR system into at least one of a mobile phone, a set top box, a music player, a video player, an entertainment unit, a navigation device, a computer, a hand-held personal communication systems (PCS) unit, a portable data unit, and a fixed location data unit.
